(19) United States
(12) Patent Application Publication
(10) Pub. No.: US 2009/0184047 A1
(43) Pub. Date: Jul. 23, 2009

(54) Functionalized nanopore membranes and related methods of use

(76) Inventors: Sankaran Thayumanavan, Amherst, MA (US); Kothandam Krishnamoorthy, Amherst, MA (US); Elamprakash N. Savariar, Amherst, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/319,957

(22) Filed: Jan. 14, 2009

Related U.S. Application Data
(60) Provisional application No. 61/011,062, filed on Jan. 14, 2008.

(51) Int. Cl. B01D 71/06; B05D 5/00

(52) U.S. Cl. 210/500.34; 427/244; 210/500.27; 210/500.28; 210/500.38; 210/500.35; 210/500.4

(57) ABSTRACT

Functionalized nanopore membranes, apparatus and related methods, as can be used for selective analyte detection and/or separation.

This application claims priority benefit from application Ser. No. 61/011,062 filed Jan. 14, 2008, the entirety of which is incorporated herein by reference.

### BACKGROUND OF THE INVENTION

Considerable effort has been expended toward the functionalization of membrane nanopores and the use of such structures over a range of separation-related applications. Initial pore size is but one factor hindering useful separation. To date, most membranes employed in this manner have initial pore diameters approaching or greater than 200 nm. Such dimensions, regardless of any particular chemistry or deposition technique, preclude practical separation. For instance, most molecules of commercial interest, including proteins and nucleic acids, are dimensioned about 10 nm or less. It is often difficult or impossible to reduce pore diameter enough to invoke a particular separation mechanism. Such compounds simply pass through the membrane, unaffected and without separation.

Notwithstanding dimension, other factors can affect more basic economic considerations. For instance, while effective for certain procedures, electroless gold deposition is an expensive process involving successive deposition of Sn⁺2, silver and gold. Electrical double layer complications often arise and the overall deposition process is time-consuming, often requiring up to about 24 hours. Subsequent thiol modification of the gold surface, to enhance separation selectivity, can be problematic as the resulting thiol receptors are often clustered rather than more uniformly positioned—another factor reducing effective separation.

Even so, but for several exceptions, such functionalization techniques have been used in conjunction with alumina membranes. Notwithstanding the aforementioned dimensional issues, alumina membranes are brittle and without structural integrity of the sort needed for practical application. As a result, there is an on-going search in the art for a general, broad-based approach for the functionalization and use of nanoporous membranes.

### SUMMARY OF THE INVENTION

In light of the foregoing, it is an object of the present invention to provide a wide range of compounds, compositions, molecular systems and/or related methods for the dimensional control and functionalization of nanoporous membranes, thereby overcoming various deficiencies and shortcomings of the prior art, such compounds, compositions, systems and methods which can be used in conjunction with corresponding articles and related apparatus. It will be understood by those skilled in the art that one or more aspects of this invention can meet certain objectives, while one or more other aspects can meet certain other objectives. Each objective may not apply equally, in all its respects, to every aspect of this invention. As such, the following objects can be viewed in the alternative with respect to any one aspect of this invention.

It is an object of the present invention to provide one or more compounds, compositions, and/or molecular systems which can be varied by number, charge and/or functionality for separation of and/or interaction with target molecule(s) or analyte(s).

It can be another object of the present invention to provide, in conjunction with such compounds, compositions and/or molecular systems, effective control of nanopore selectivity.

It can be another object of the present invention to provide such a method or system for flexible design and control of nanopore size and functionality, and a corresponding approach for differential analyte interaction within a mixture of analytes or as between separate analyte media.

It can be another object of the present invention to provide such methods and corresponding articles and apparatus using commercially available compounds and/or compounds readily available via conventional synthetic techniques, quickly and at a fraction of the cost associated with the prior art.

Other objects, features, benefits and advantages of the present invention will be apparent from this summary and the following descriptions of certain embodiments, and will be readily apparent to those skilled in the art having knowledge of various separation techniques. Such objects, features, benefits and advantages will be apparent from the above as taken into conjunction with the accompanying examples, data, figures and all reasonable inferences to be drawn therefrom.

In part, the present invention can be directed to a method of preparing a functionalized nanopore coating composition. Such a method can comprise providing a membrane component comprising nanodimensioned pores therethrough and walls thereabout; and contacting the pore walls with at least a first polymeric compound comprising at least one separatory substituent, each said contact reducing pore diameter. As will be understood to those skilled in the art made aware of this invention, a separatory substituent or moiety can comprise a functional group or functionality electrostatically, non-electrostatically or otherwise interactive (e.g., to promote or facilitate separation or transport) with a compound, composition and/or analyte of interest. In certain embodiments, such contact can comprise successive depositions of a first polymeric compound. In certain other embodiments, such contact can comprise contacting the first polymeric compound with a second polymeric compound comprising at least one separatory substituent. Iterative contact of first and/or second polymeric compounds or components, or optionally one or more additional polymeric compounds/components, can upon each contact reduce pore diameter to a dimension at least partially effective for selective interaction of an analyte positioned therein.

With regard to such iterative contact, a first polymeric component can comprise at least a portion thereof (e.g., a separatory substituent) characterized as having a net charge. In accordance with one or more such embodiments, a second polymeric component can comprise a portion thereof characterized by a net charge opposite that of the first polymeric component, such that the first and second polymeric components can be contacted one to another under conditions or at a pH conducive for electrostatic interaction therebetween. For instance, the pH can be varied to provide or change the net electrical charge of a portion of a first polymeric component sufficient to promote or provide electrostatic interaction with a second polymeric component. Nonetheless, consistent with various broader aspects of this invention, without limitation to any one theory or mode of operation, a first polymeric compound can be adsorbed on, connected with and/or coupled to a porous membrane structure, and a second polymeric compound can be absorbed on, connected with and/or coupled to any other polymeric compound.

Regardless of the number or iterations of any such polymeric contact, each separatory substituent thereof can be electrostatically, non-electrostatically or otherwise interactive with an analyte positioned proximate thereto. As illustrated herein and as would be understood by those skilled in the art, such interaction can be understood with regard to analyte transport through such nanopores and/or separation or isolation of an analyte with respect to a membrane component. Accordingly, such a method can comprise contacting a first polymeric compound with a second polymeric compound, each compound as can be separately and independently interactive with one or more analytes introduced thereto. As illustrated below, such a first polymeric compound can be used to selectively interact with one or more first analytes. Subsequent contact of the first polymeric compound with a second polymeric compound can be used, optionally and/or with respect to the same or different membrane components, for subsequent, separate interaction with one or more second analytes. Accordingly, depending upon identity of the separatory substituent(s) of each such polymeric compound, such a method can also be considered in the context of the functionalization or sequential functionalization of a nanoporous membrane.

In part, this invention can also be directed to a method of using polymeric deposition to affect nanoporous membrane separation. Such a method can comprise providing a nanoporous membrane component; coupling or contacting a pore wall of the membrane with or depositing thereon at least one polymeric compound comprising at least one separatory substituent, each said contact or deposition reducing pore diameter; and contacting a membrane component with a fluid medium comprising a first analyte, the last deposited polymeric compound selectively interactive with the first analyte. As would be understood by those skilled in the art made aware of this invention, such a last deposited compound and/or separatory substituent thereof can be interactive with at least one of a hydrophilic analyte, a hydrophobic analyte, analyte dimension, and/or an analyte comprising a net charge.

In certain embodiments, such a polymeric component can comprise a substituent comprising a negatively charged functional group, with a cationic analyte selectively separated from the fluid medium with the membrane component. In certain other embodiments, such a polymeric compound can comprise a substituent comprising a positively charged functional group, with an anionic analyte selectively separated from the fluid medium by the membrane component. In yet other embodiments, such a polymeric component can comprise a substituent comprising an uncharged functional group, with a hydrophobic analyte selectively separated from the fluid medium by the membrane component.

Regardless of compound number or identity, pore wall contact can comprise contacting such a last deposited polymeric compound with another polymeric compound, the other polymeric compound comprising at least one separatory substituent selectively interactive with a second analyte. Subsequent introduction of a fluid medium comprising such a second analyte can be used to selectively transport or separate such an analyte from the fluid medium. Alternatively, contact or coupling of any polymeric compounds can be considered within the context of analyte dimension. Any such successive or iterative contact or couplings can be of a number and to extent sufficient to achieve desired pore diameter reduction, to further promote or facilitate analyte interaction.

In part, this invention can also be directed to a system for analyte interaction. Such a system can comprise a nanoporous membrane component comprising nanopores with diameter dimensions ranging from about 10 nm to about 45 nm or as would otherwise be known in the art; and at least one polymeric component comprising a separatory substituent, the polymeric component coupled to the nanopore walls, each coupled polymeric component at least partially sufficient to reduce nanopore diameter dimension for analyte interaction. The separatory substituent of the last coupled polymeric component can be interactive with at least of a hydrophilic analyte, a hydrophobic analyte and/or an analyte comprising a net charge.

In certain embodiments, the last coupled polymeric component can comprise a substituent comprising a negatively charged functional group, with a cationic analyte selectively separated with the membrane component. In certain other embodiments, the last coupled polymeric component can comprise a substituent comprising a positively charged functional group, with an anionic analyte selectively separated from a fluid medium by the membrane component. In yet other embodiments, the last coupled polymeric component can comprise a substituent comprising an uncharged functional group, with a hydrophobic analyte selectively separated from a fluid medium by the membrane component.

In part, this invention can also be directed to a separation apparatus comprising a membrane component comprising opposed sides and at least one aperture therethrough, at least one polymeric component comprising a separatory substituent and coupled to a wall component thereof, with the aperture having a diameter or cross-dimension ranging from about 1 nm to about 100 nm or more. In certain embodiments, such a cross-dimension can be less than about 25 nm. Regardless, such a polymeric component can be coupled to an aperture wall, such as with but not limited to at least one other polymeric component, the number of couplings at least partially sufficient to provide desired cross-dimension. Regardless, in certain embodiments, the membrane component can comprise a polycarbonate material. Where such a component comprises a nanoporous polycarbonate membrane, at least one of the nanopores therethrough has an initial diameter dimension ranging from about 5 nm to about 45 nm.

As provided herein and illustrated below, membrane pores can be designed and fine-tuned with respect to both functionality and size through layer-by-layer coupling or deposition of various polymeric components. Such functionalization and resulting pore diameter can be used for screening or identifying a lead or active compound of therapeutic interest and separation, isolation, sensing, detection and/or transport of analytes or target molecules based on charge, hydrophobicity and/or size, and can be provided by a range of polymeric compounds and/or components, limited only by synthetic method and available starting materials. For example, a variety of polymeric compounds, can be based on or derived from economic, commercially-available polyacrylic acid, and can include a range of conducting polymers or conducting polymer dispersions as would be know in the art. Various other non-limiting, representative polymeric components include those provided in FIG. 1. As evident therein, polymeric backbone can vary and is limited only by way of providing, by way of molecular and structural configuration, a separatory substituent sufficient for particular analyte interaction. Accordingly, as seen therein, one or more acid (or acid salt) functionalities can be presented by any one (e.g., polyacrylate, polyacrylamide, polystyrene, polyalkyleneimine, polyheterocyclic, etc.) or more polymeric backbones. Likewise, a variety of alkyl, amide and amine (or ammonium salt) functionalities can be likewise provided by similar such polymeric systems. A useful multi-functional approach can be provided by the use of dendrimers, representative embodiments of which are also shown in FIG. 1. As a variation on the methods, systems and/or apparatus of this invention, potential modulated separation of compounds, compositions and/or analytes can be achieved in conjunction with one or more of the aforementioned considerations. For example, conducting polymers with one or more ionic separatory substituents and conducting polymers stabilized by ionic polymers can be used to modify the pores of a membrane component. With opposed electrical contacts and a voltage source coupled thereto, such a modified membrane can be used as a working electrode to facilitate separation and/or transport.

In particular, several polymers of FIG. 1 (e.g., designated C11 and Bn) can be used in conjunction with certain non-limiting methods, systems and apparatus embodiments of this invention. Such compounds/components are representative of a larger group of polymers that can be considered as having a certain degree of amphiphilic character; that is, as can be considered as having one or more hydrophilic/charged substituents and one or more hydrophobic substituents. Accordingly, such compound/components can exhibit variable selectivity depending upon a particular analyte and corresponding fluid medium. For instance, such a hydrophilic/charged substituent, irrespective of a particular polymeric backbone, can be invoked for interaction with a charged analyte and an aqueous medium. Conversely, such a hydrophobic substituent, regardless polymeric backbone, can be invoked for interaction with an uncharged analyte and a non-aqueous medium. Other useful polymers and corresponding monomeric units are limited only by amphiphilic properties, functions and behavior in a fluid or solvent medium or, alternatively, with respect to interaction with a particular analyte. Such polymers and corresponding monomeric units include those described in co-pending application Ser. No. 11/184,324, filed Jul. 19, 2005, the entirety of which is incorporated herein by reference, in particular, those representative, non-limiting compounds referenced in FIGS. 1, 2A-2B and Table 1, thereof.

### BRIEF DESCRIPTION OF THE DRAWINGS

FIG. 1 illustrates several non-limiting polymeric compounds, in accordance with certain embodiments of this invention.

FIGS. 2A-2C schematically illustrate certain apparatus embodiments, in accordance with this invention.

FIGS. 3A-B graphically represent the relative absence of analyte interaction using non-functional membrane components of the prior art.

FIGS. 4A-4C graphically illustrate selective and sequential separation of charged analytes.

FIGS. 5A-5E graphically illustrate enhanced separation with greater charged density (5A), switchable separation by subsequent polymer deposition (5B), change in ionic strength and dendrimer generation (5C-D) and enhanced selectivity of a hydrophobic analyte (5E), in accordance with certain embodiments of this invention.

FIGS. 6A-B graphically illustrate, switchable separation, in accordance with certain embodiments of this invention.

FIGS. 7A-C provide transmission electron micrograph images of polymeric nanotube structural configurations isolated upon membrane removal, in accordance with certain embodiments of this invention (A: polymer nanotube; B: showing full tube length; and C: magnified).

FIGS. 8A-D. Schematic of polycarbonate membrane modified with PEDOT-PSS (A), the UV-vis spectra of the PEDOT-PSS modified membrane (B), the CV of PEDOT-PSS modified polycarbonate membrane (C) and a graphic illustration of polymer-electrode conductance (D).

FIG. 9. The U-tube set up for potential modulated separation of molecules using the PEDOT-PSS modified polycarbonate membrane as working electrode. The cell can be filled with liquid electrolytes or agar-agar gel.

FIG. 10. Separation of myoglobin from FITC-BSA by using A) C6 polymer coated membrane B) C11 polymer coated membrane.

FIG. 11. Separation of BHB from FITC-BSA using C6 polymer coated membrane.

FIG. 12. A) Ferritin nanotube, B) Enlarged image of A showing the iron oxide core (black dots) of the ferritin.

FIG. 13. A) Separation of Sodium naphthalene sulfonate (small anion, ▪) from a mixture with Eriochrome black T (large anion, ▴). B) The U-tube set up showing the large anion and small anion separation by a C6 polymer-PEI modified polycarbonate membrane.

FIG. 14. Schematic representation of a nanotube sensor apparatus, in accordance with this invention, configured with a biopotentiostat to measure resistance change with analyte deposition.

FIG. 15. A schematic illustration of an injection/pressure sensor apparatus, to monitor decreasing pore dimension with analyte interaction.

FIG. 16. Sensor response as a function of VEGF concentration using a PEDOT-PSS nanotransducer.

### DETAILED DESCRIPTION OF CERTAIN EMBODIMENTS

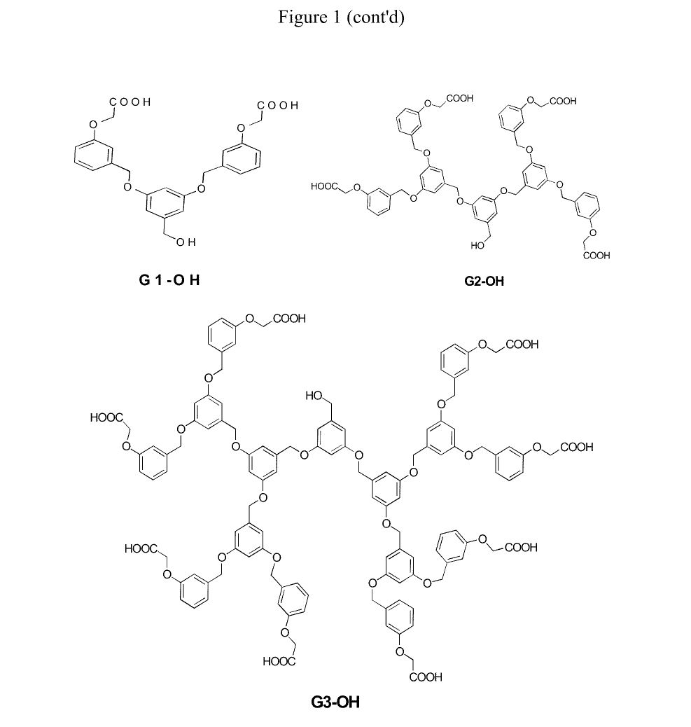

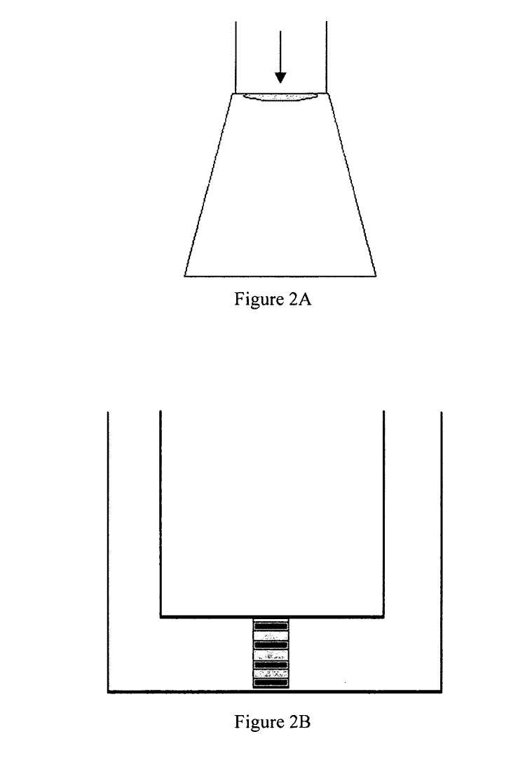

Referring to FIGS. 2A-2C, with choice of membrane component and material, nanopores can be functionalized, typically in less than an hour, by simply filtering a corresponding polymer solution through the membrane component. As mentioned above, the polymer component can be absorbed on, connected with, linked or otherwise coupled to the pore wall, such contact as would be understood by those skilled in the art made aware of this invention. (A schematic illustration is provided in FIG. 2A). With reference to FIG. 2B, nanopores can be aligned parallel to analyte flow through a membrane or corresponding separation apparatus. Alternatively, as illustrated in FIG. 2C, a nanoporous membrane can be mounted in a U-tube configuration with a feed compartment containing e.g. cationic and/or anionic analytes, and a buffer-containing permeate compartment opposite thereto.

By way of example, commercial track-etched polycarbonate (PC) membranes can be obtained with a thin layer of poly(vinyl pyrrolidone) (PVP) functionalities in the walls of the nanopores ranging from 10 nm to 20 μm in diameter. Using the nitrogen and carbonyl groups in PVP to coordinate Sn²⁺ ions, the polyvalent nature of the anionic polymers can then adhere to stannous ions inside the nanopores by filtering the polymer solution. This entire procedure is typically done within 30 minutes or less, which renders the polymer modified membrane preparation extremely simple to execute. Since the functional groups are attached to the polymers prior to the membrane-incorporation, the nanopores of the membranes can be uniformly decorated with specific functionalities with great ease. The vacuum filtration used in the modification procedure not only accelerates the process, but also circumvents any complications that arise due to the adsorption of the charged polymer on the pore mouth of the membrane and eventual blockade of the pores.

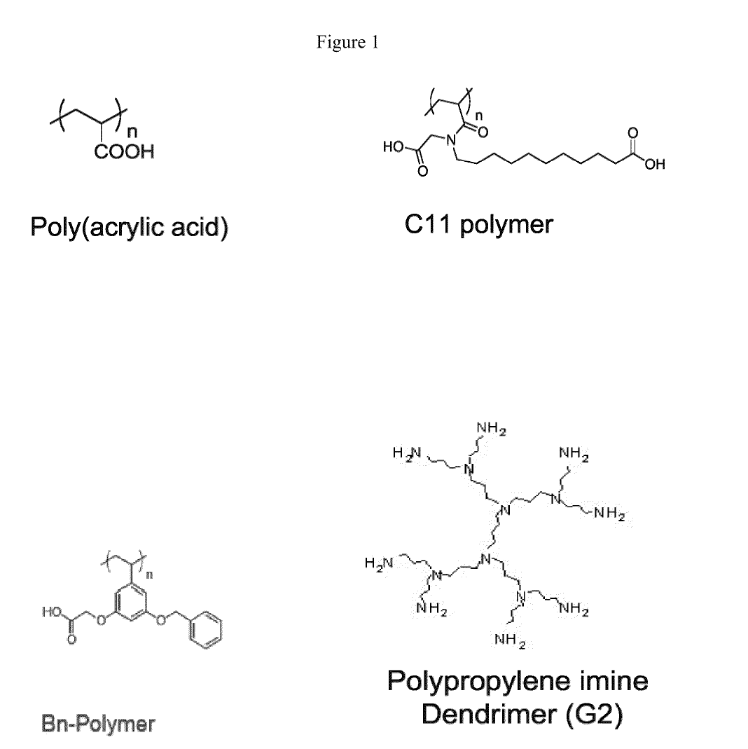

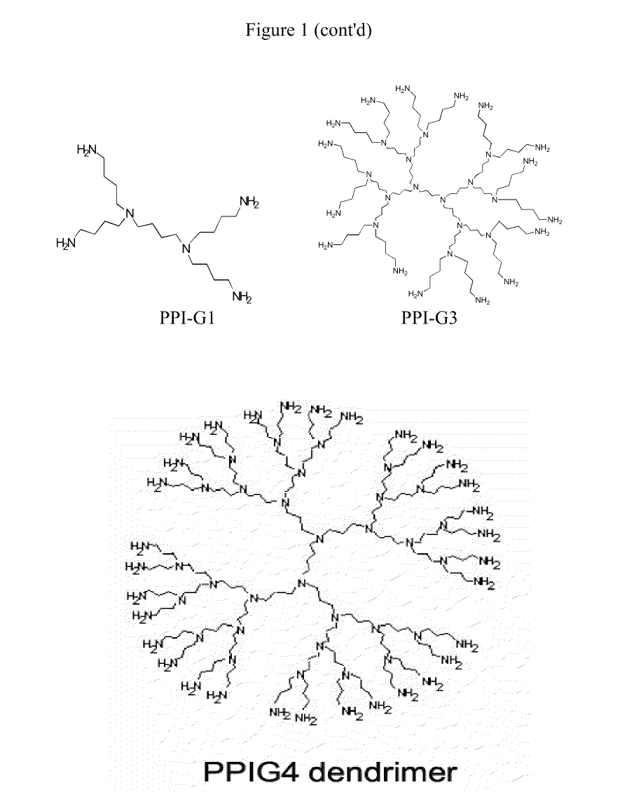

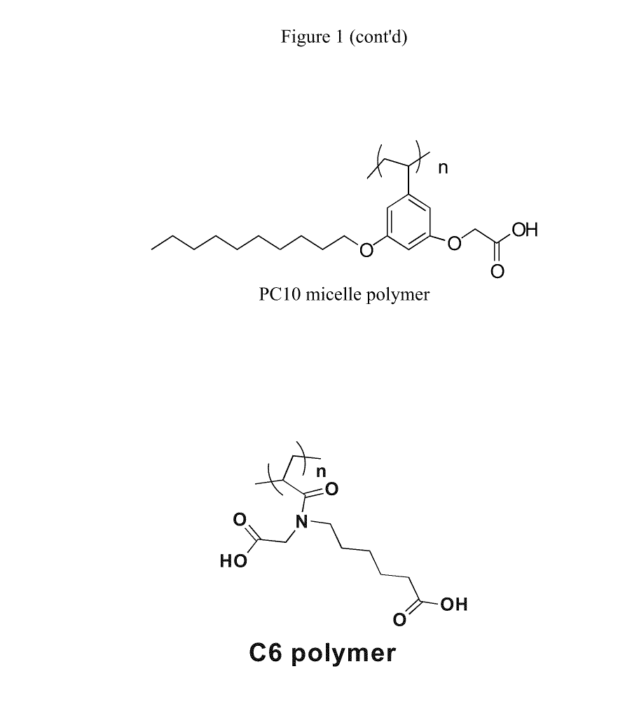

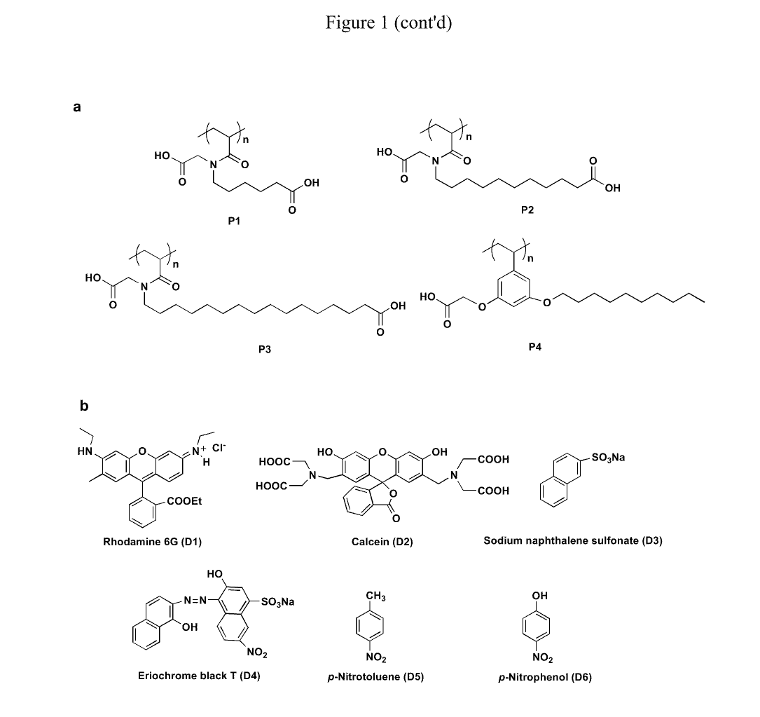

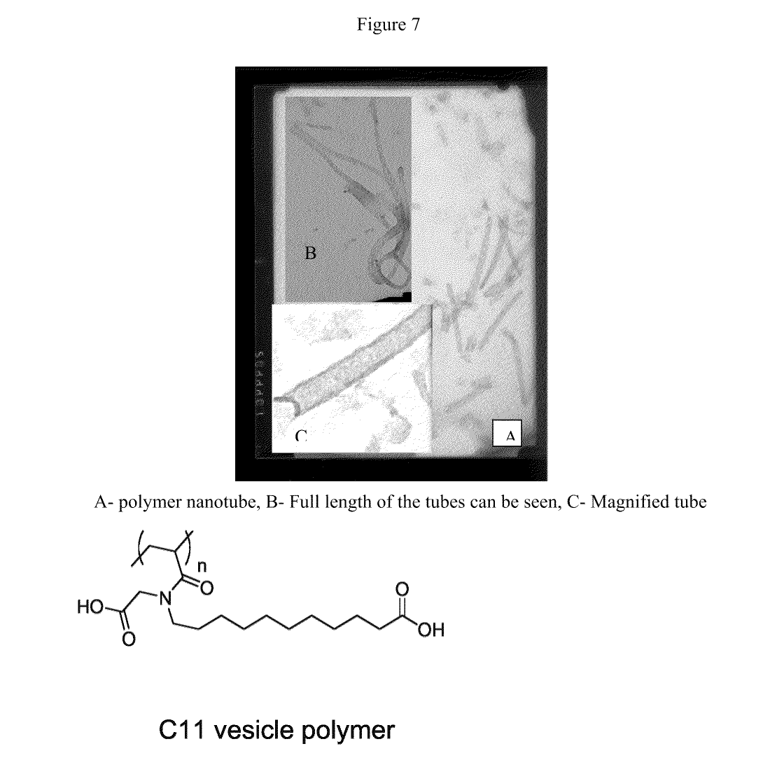

Relating to various apparatus and compositional aspects of this invention, dissolution of a polycarbonate membrane can be used to show the extent of pore wall coating available through use of this invention: stable polymeric nanotubes can be isolated. (See, the transmission electron micrograph [TEM] image of FIG. 7). For instance, a thin-walled polymer nanotube was obtained from the contact with or deposition of polymers designated P1 and C11 (FIG. 1).

More specifically, to ascertain polymer nanotubule formation, the polymer P2 modified template was treated to liberate the polymer and visualized using TEM. TEM images of liberated polymer nanostructures (FIG. 7), indicate that the polymer has assembled to form tubes and the modification indeed occurs through the full length of the pore. The polymer nanostructure is indeed a tube and not a rod. The diameter of the nanotube formed from the functionalization using P1 is 50 nm, which is higher than the pore diameter claimed by the membrane manufacturer.

Scanning electron microscopy (SEM) was used to analyze the variations in pore diameter upon polymer modification. The images of polymer modified membrane (not shown) provide clear visual evidence for decrease in the pore diameter compared to unmodified membranes. However, quantifying these changes using SEM was complicated, since the unmodified membranes are not isoporous. As an alternate approach to measure the average pore diameter of the polymer nanotubules, the pressure drop across the polymer-modified membrane was monitored during water flow. A calibration plot was obtained by measuring the pressure drop across the four commercially available membranes with pore diameters 10, 30, 50 and 80 nm, showing the change in pressure as a function of time for a P3 modified membrane. Similar experiments were carried out using other polymer modified membranes and the measured pore sizes are summarized in Table 1.

TABLE 1
Permeation data and pore diameter
of polymer modified membranes.

| | | Transport rate of | | |
|---|---|---|---|---|
| | | Molecules (t) | | |
| | | (M/s)^{b} | | |
| Polymer | Pore diameter | Rhodamine | Calcein | Separation |
| nanotubule | (nm)^{a} | 6G (D1) | (D2) | factor (α)^{c} |
| PAA | 25 | 13.45 × 10⁻⁷ | 10 × 10⁻⁷ | 1.4 |
| P1 | 22 | 7.9 × 10⁻⁷ | 6.6 × 10⁻⁷ | 1.2 |
| P2 | 9 | 3.5 × 10⁻⁷ | 1.0 × 10⁻⁷ | 3.5 |
| P3 | 8 | 2.9 × 10⁻⁷ | 1.4 × 10⁻⁷ | 2.1 |
| P1-PEI | 6 | 0.15 × 10⁻⁷ | 0.41 × 10⁻⁷ | 2.7 |

^{a}estimated by measuring the pressure drop across the membrane upon water diffusion,
^{b}measured by the ratio of moles of dye molecules transported as a function of time,
^{c}ratio of transport rate of cationic and anionic dye molecules.

An interesting feature is that the pore size of these membranes can be tuned, while simultaneously functionalizing the interiors of these pores. To demonstrate, with a 30 nm membrane, a non-self assembling anionic polymer, poly(acrylic acid) was used to modify the membrane pores. This modification resulted in a small decrease in pore size of the membrane from 30 to 25 nm. Ability to tune pore size can contribute to versatility. For example, small molecule separation will be more effective with smaller pore sizes, enhancing analyte encounter membrane with functionality.

The polymer P2 has been shown to form vesicle like nanoassemblies in aqueous phase. It was hypothesized that if the nanoassemblies do not completely disassemble inside the nanopores, the pore size will be reduced significantly in a single operation. Indeed, when the 30 nm pore was functionalized with P2, the pore size reduced to 9 nm. A structurally similar polymer P3 provided a reduction of the pore size to 8 nm. It should be noted here that the size of the vesicular assembly from P2 is 60 nm in water, but the pore diameter in the membrane is reduced only by ˜20 nm, when used for membrane modification. This clearly indicates that the larger assemblies have partially deformed while passing through the nanopores. If the hypothesis regarding pre-assembly as the factor responsible for this significant reduction in pore size were true, then a functionally similar polymer that does not exhibit nanoassembly formation should not provide the drastic reduction in pore size. To test this possibility, the nanopores were functionalized with P1 and the pore size reduced only to 22 nm (P1 does not exhibit a self-assembled structure). This size is closer to poly(acrylic acid) than to P2 or P3, which supports the hypothesis.

As mentioned above, by reducing the pore size of the membrane, it may be possible to simultaneously modify functionalities within the membrane. In addition, the possibility of tuning the functional group presentation to a cationic functionality while changing the pore size would enhance the capabilities of this procedure. To demonstrate, layer-by-layer type self-assembly was accomplished within the nanopores using polyethyleneimine (PEI) as the second coating following the P1 modification. (Lvov, Y., Decher, G. and Mohwald, H., Langmuir 9, 481-486 (1993); Ferreira, M. and Rubner, M. F., Macromolecules 28, 7107-7114 (1995).) This functionalization provided a reduction in pore size to 6 nm—understandable, as PEI provides a rather drastic change in pore size, because of its branched architecture.

To demonstrate the versatility of the pore size control and functional group presentations within membrane nanopores, molecular separations were based on differences in charge, size, or hydrophobicity. A typical separation experiment was carried out using a U-tube set up, in which the feed and reservoir compartments were separated by the functionalized nanoporous membrane. The relative concentration of the two analytes in the reservoir was periodically monitored and the rate of diffusion was calculated. The slope of the plot between time and concentration of the transported molecules was taken as rate of transport (t). The ratio of ‘t’ for two analytes is the separation factor α, which can be a ‘Figure of Merit’ for the molecular differentiation inside the nanopore.

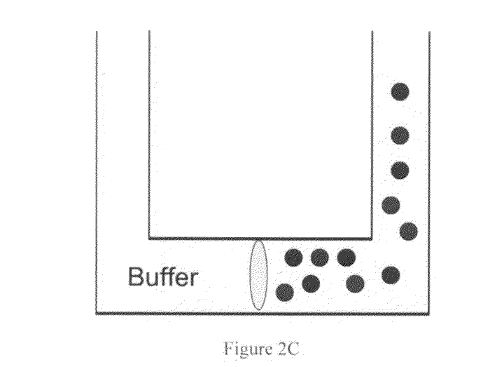

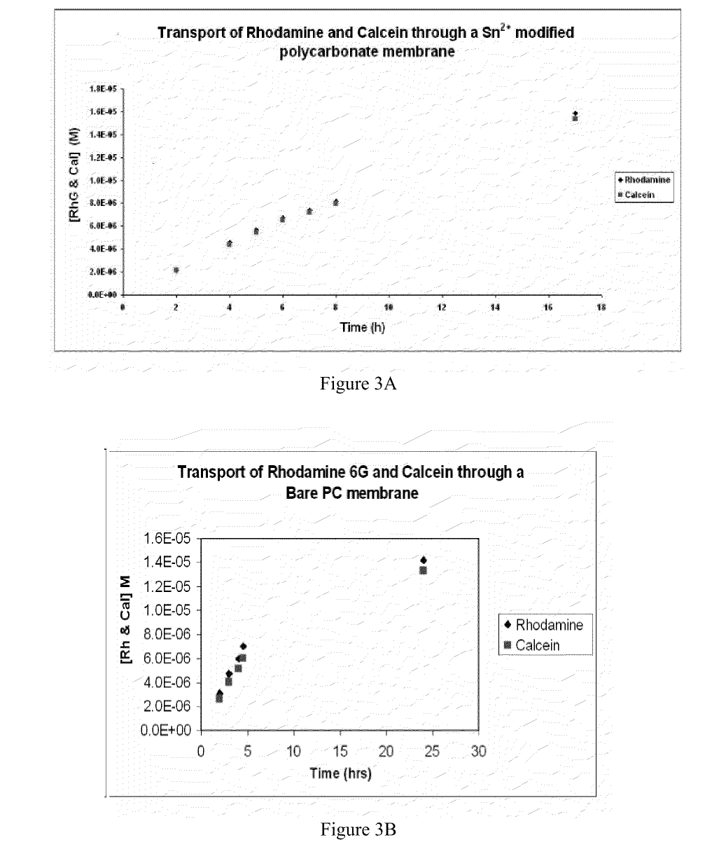

Various aspects and benefits relating to certain embodiments of this invention can be understood with reference to FIGS. 3A and 3B. For the purpose of illustration, Rhodamine 6G is a cationic analyte and calcein is an anionic analyte. (See, FIG. 1.) Neither a bare polycarbonate (PC) membrane (30 nm pore) nor an Sn²⁺ modified membrane discriminate analytes of two different charges. These two analyte molecules are similar in structure and size, but are oppositely charged and exhibit distinct spectroscopic features that were utilized to estimate the relative concentration of the two molecules. When the separation experiment was carried out at pH 7.3 phosphate buffer solution containing a mixture of 1×0⁻⁴ M D1 and D2, the separation factor (α) was found to be 1.0 for the unfunctionalized membrane, indicating no selectivity.

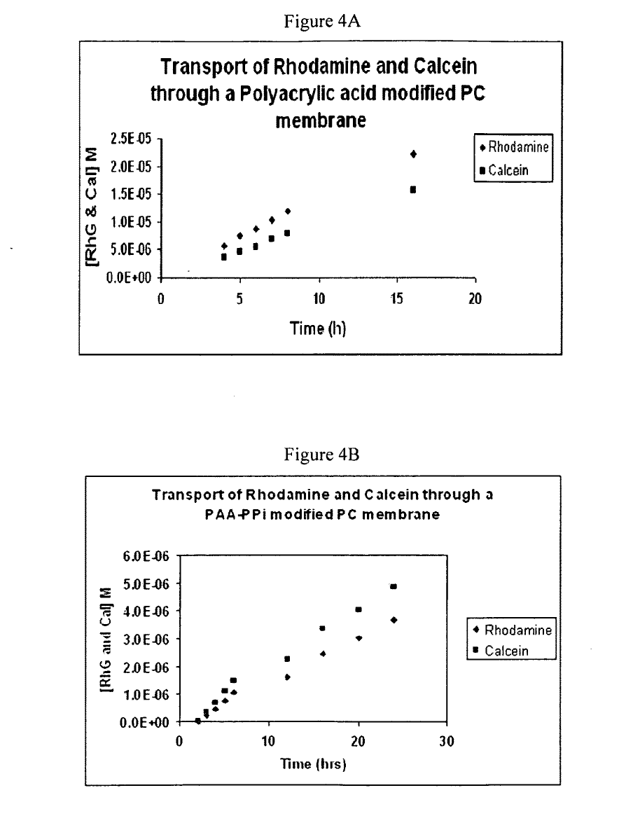

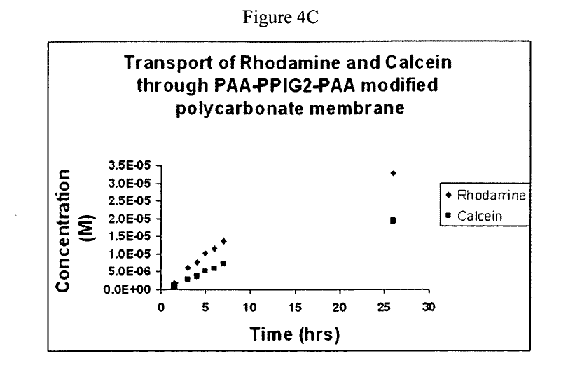

The effects of successive polymer contact is evident upon consideration of FIGS. 4A-4C. Polyacrylic acid (PAA)—functionalized nanopores preferentially separate cationic Rhodamine 6G (See, FIG. 4A) with a moderate increase in α to 1.4. The difference in transport across the membrane is low, presumably because the size of the two analytes is less than 2 nm and the pore size is 25 nm. To verify, separation was achieved using P1 functionalized membrane, which has pore size close to poly(acrylic acid) modified membrane. The separation efficiency was found to be similar (α of 1.2) to poly(acrylic acid). If large pore size is indeed the reason for the lack of selectivity, then the separation efficiency should increase for anionically functionalized membranes with smaller pore sizes. To test this possibility, two experiments were carried out: (i) functionalized a 10 nm membrane with P1, and (ii) used pre-assembled polymer such as P2 to reduce the size of the 30 nm membrane to 8 nm. Indeed both these modifications provided significant enhancement in α values to 2.3 and 3.5 respectively.

The structural similarities of P2 and P3 also provided an opportunity to identify the effect of functional group density in these separation events. The structure of the polymers and the pore size of the membranes in these two cases are very similar (Table 1). However, P3 has five more carbons in between the carboxylate units compared to P2, making the former polymer less dense in terms of the carboxylate units. Impacting separation, the a value for P3 is only 2.1, compared to 3.5 for P2, even though the pore size of the former is 1 nm lesser than the latter. This suggests that the density of functionalities within the nanoporous membranes plays a significant role in the molecular separation, i.e. the overall recognition events.

In the experiments described above, the assumption is that the separation is primarily based on electrostatics. This assumption can be corroborated with two experiments: (i) reduce the ionic strength of the solution and thus diminish the charge screening by the solution to provide better interaction; (ii) demonstrate that the selectivity for the two analytes above can be switched by changing the charge displayed in the nanopore interior. The above-mentioned experiments were carried out using a 100 mM phosphate buffer and 20 mM NaCl. When this is reduced to 10 mM buffer and 2 mM NaCl in the case of P1 functionalized membrane, the separation factor α improves from 1.2 to 2.3. By functionalizing the nanopores with a layer of a second polymeric component, i.e. a cationic dendrimer (See, FIG. 1), selective separation of the anionic calcein was achieved. (See, FIG. 4B). Selectivity can be reversed, again, by subsequent deposition of another PAA component layer, to again preferentially separate Rhodamine 6G. (See, FIG. 4C).

Alternatively, to further illustrate such embodiments, nanopore size can be precisely controlled using a series of anionic dendrimers. To demonstrate, a 10 nm polycarbonate membrane was functionalized with SnCl₂ and modified with G1-OH, G2-OH or G3-OH benzylether carboxylic acid dendrimer (FIG. 1). The pore size of the membrane decreased from 10 nm to 7.4 nm for G1-OH, 10 nm to 6.1 nm for G2-OH and 10 nm to 3.8 nm for G3-OH (Table 2). In such a manner, depending on deposited polymer or dendrimer, a pore diameter of about 1 nm can be obtained. The separation factor of rhodamine 6G (slope of rate of diffusion of rhodamine 6G/slope of rate of diffusion of calcein) also increased with an increase of dendrimer generation (Table 2).

TABLE 2
Separation and pore size of the dendrimer
modified 10 nm membranes

| | Separation factor for | Pore size |
|---|---|---|
| Dendrimer | rhodamine 6G | (nm) |
| G1-OH | 1.5 | 7.4 |
| G2-OH | 2.7 | 7.1 |
| G3-OH | 9.2 | 3.8 |

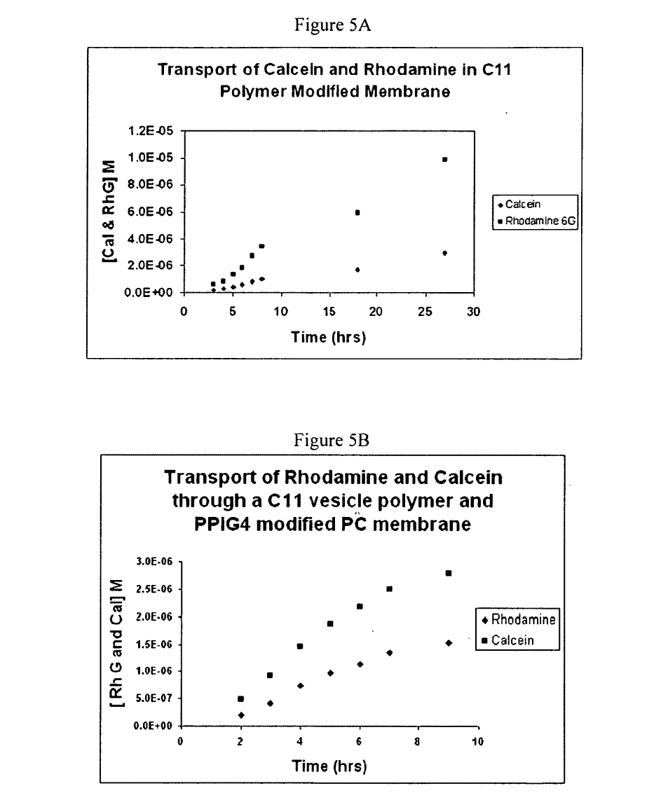

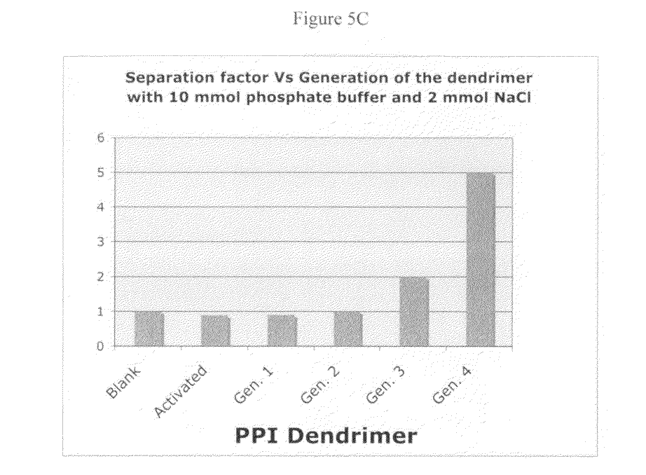

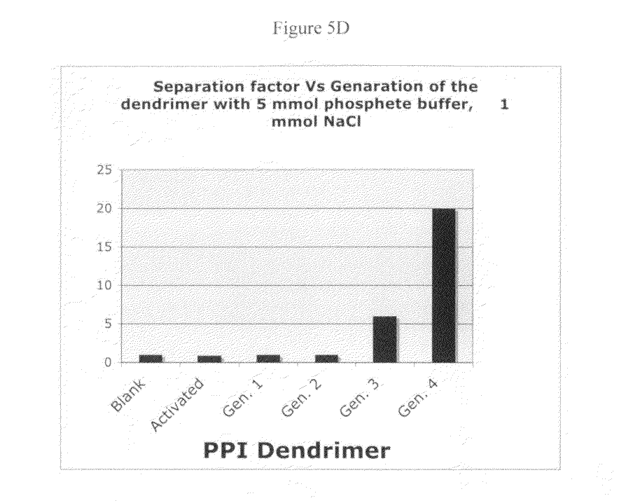

From another perspective, using layer-by-layer deposition, degree of separation can be increased, illustrating the use of smaller pore diameters to separate smaller analytes and/or target molecules. With reference to FIG. 1 and FIGS. 5A-D, the C11 polymer provides greater charge density and hydrophobicity (as compared to PAA), and was used to functionalize PC nanopores. Analytes were separated more efficiently (again, as compared to PAA) as shown in FIG. 5A. By subsequent deposition of a layer of a cationic dendrimer (i.e., PPIG4, in FIG. 1), selectivity was switched and the anionic analyte was preferentially separated.

The efficiency of the separation can also improved by decreasing the ionic strength as well as increasing dendrimer generation. A systematic study was carried out by depositing polyacrylic acid followed by cationic poly(propyleneimine) dendrimers (PPI) on a Sn²⁺-modified 30 nm polycarbonate membrane. The separation factor for calcein (slope of rate of diffusion of calcein/slope of rate of diffusion of rhodamine 6G) is increased upon decreasing ionic strength as well as increasing dendrimer generation. (FIGS. 5C-D.)

Hydrophobicity can Also be a Basis for Separation, for Instance Using a polymer that contains one carboxylate functionality to bind to the Sn²⁺ ion and a hydrophobic functionality to decorate the nanopores, viz. P4 (FIG. 1). The hydrophobic group display should favor the transport of hydrophobic molecules through the membrane relative to the hydrophilic ones, as confirmed using p-nitrotoluene (D5) and p-nitrophenol (D6). While similar in size, D5 is more hydrophobic compared to D6. The separation factor α obtained in this experiment was 1.3 compared to 0.8 for the unmodified membrane. Considering the rather small difference in hydrophobicity, this increase in separation upon decorating the nanopore with P4 is quite reasonable. As discussed above, separation can be enhanced with decreasing ionic strength. Analogous results are shown with separation from toluene (FIG. 5E).

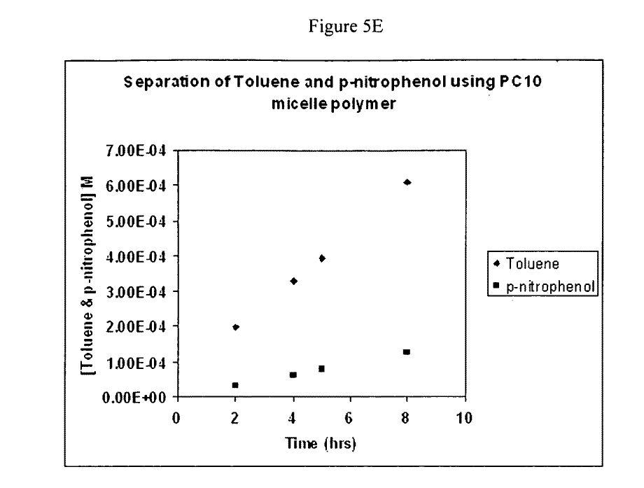

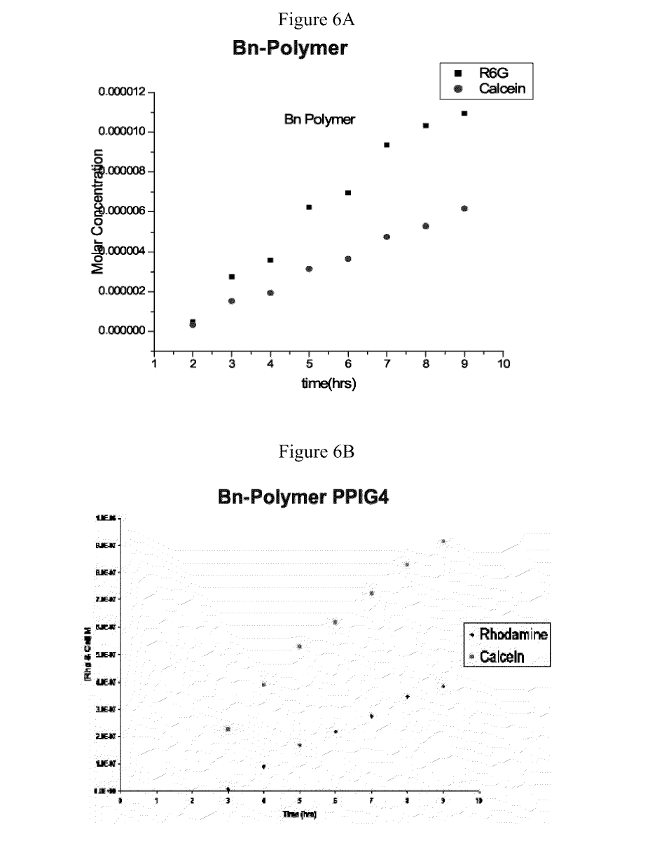

Alternatively, as graphically represented in FIG. 6A, an amphiphilic polymer, designated Bn, (FIG. 1) can also be used to functionalize PC nanopores. The corresponding membranes selectively separated positively charged analyte; and by depositing a subsequent layer of cationic dendrimer, selectivity (i.e. separation) can be switched for an anionic analyte. (See FIG. 6B).

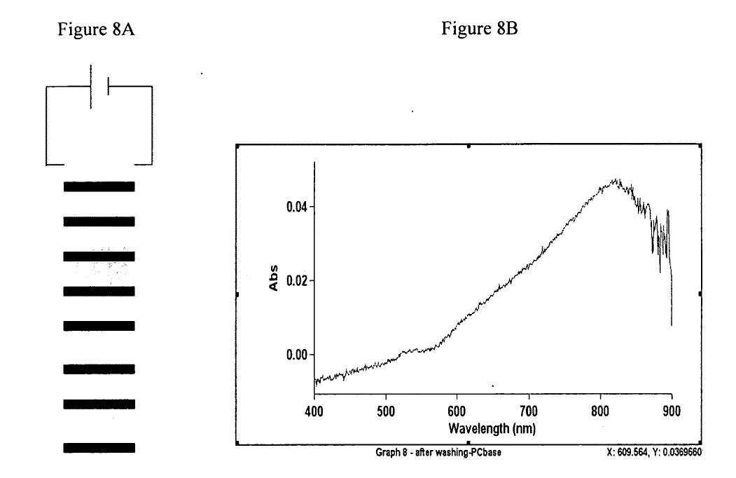

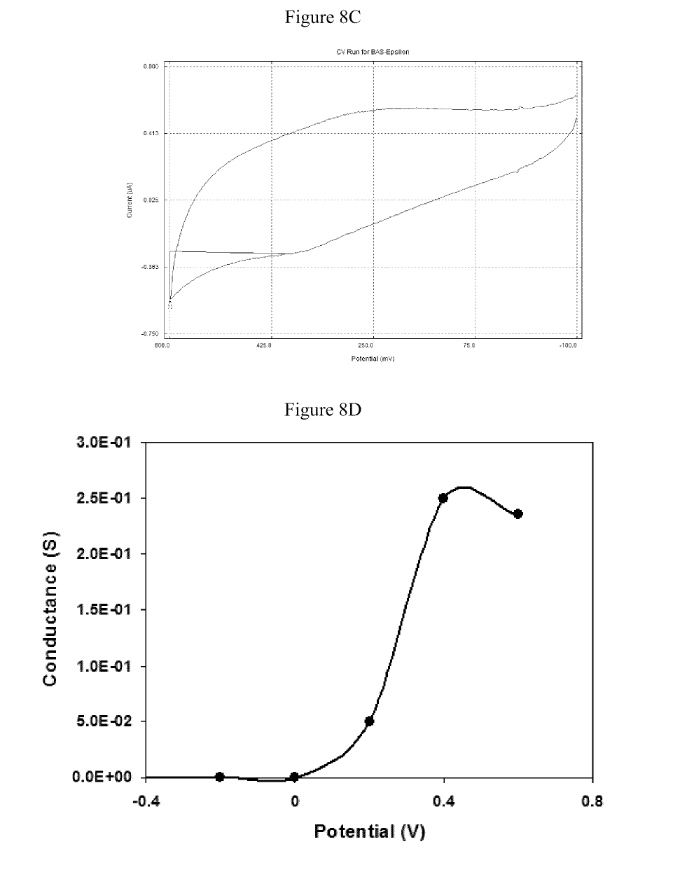

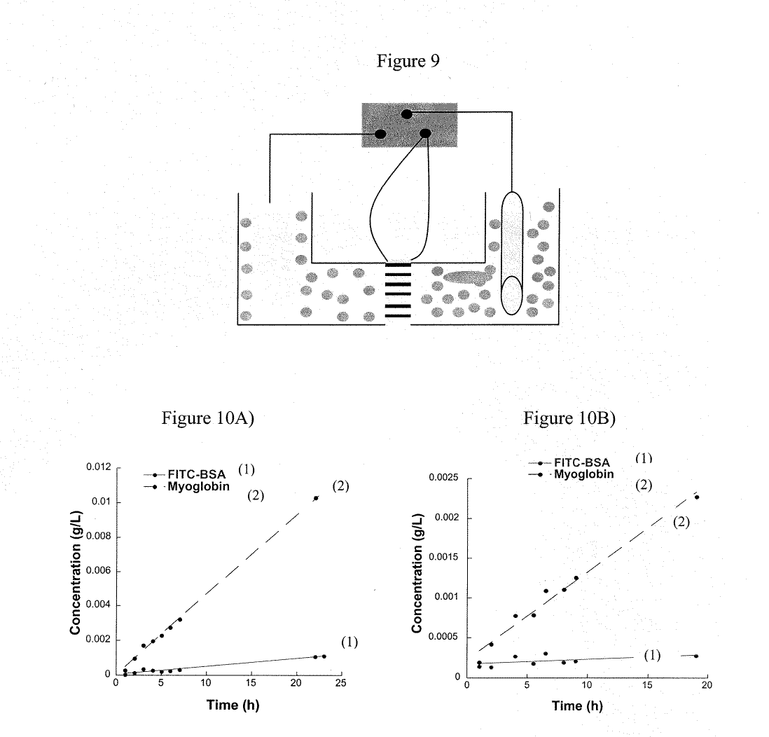

Relating to and demonstrating various other embodiments of this invention, an aqueous dispersion of poly(ethylenedioxythiophene), (PEDOT) particles stabilized by polystyrene sulfonate (PSS), (commercially available as PEDOT-PSS) was filtered through a Sn²⁺ modified polycarbonate membrane. The UV-vis spectrum shows that the pores are modified by PEDOT-PSS. (See, FIGS. 8A-B.) For in situ measurement, gold was evaporated on both faces of the membrane prior to polymer incorporation and the polymer was annealed at 100° C. for 1 hour. With an applied potential thereacross, the membrane was used as working electrode to facilitate separation/transport. A CV shows the redox of PEDOT-PSS, indicating the contact between gold and polymer. (FIG. 8C) An in situ conductivity measurement was also carried out: the conductance of the polymer was 5×10⁻⁴ S at −0.4 V and increased to 2.5×10⁻¹ S at 0.4 V as shown in FIG. 8D. The three orders increase in conductance as a function of applied potential also indicates the good contact between polymer transducers and the gold electrodes. Such a membrane/electrode can be positioned in a U-tube cell or related apparatus, between a feed component containing analytes and a permeate component. (FIG. 9) Various other conducting polymers and/or dispersions thereof useful in conjunction herewith will be understood by those skilled in the art made aware of this invention, such conducting polymers including but not limited to carboxylate-functionalized polythiophenes, and such dispersions including but not limited to polypyrole particles in dodecylbenzene sulfonate.

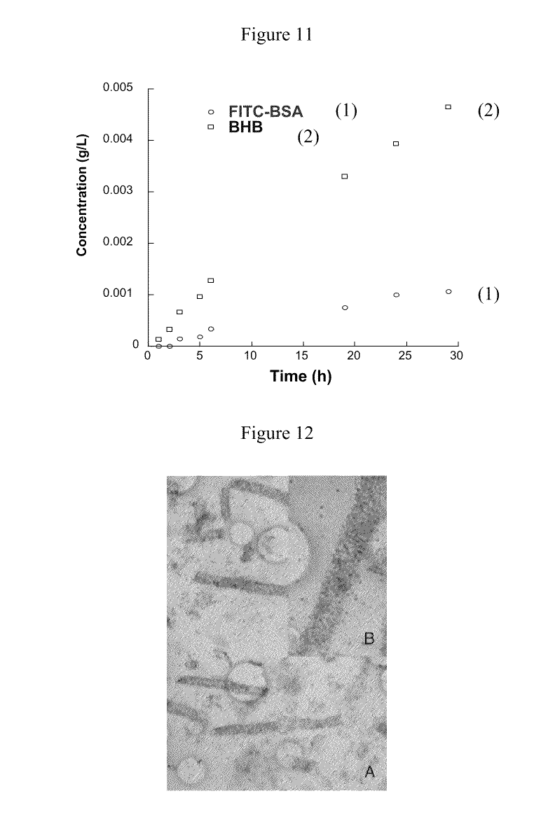

Relating to and exploring various other applications of this invention, a C6 polymer functionalized polycarbonate membrane, (e.g., FIG. 1) was used to separate biomolecules by size, charge etc. As represented in FIG. 10A, the separation of myoglobin from bovine serum albumin (BSA) was achieved. Myoglobin is smaller in size (˜16.7 KDa), whereas BSA is much larger than myoglobin (˜66 KDa). As a result myoglobin has faster diffusion rate. Much better separation was achieved with use of C11 coated membrane (See FIG. 10B.). In another experiment, a C6 polymer coated membrane is shown to separate proteins having similar size but different charge. (See, FIG. 11.) Separation of bovine hemoglobin (BHB; isoelectric point, pI ˜7.2) from bovine serum albumin (pI ˜4.6) was achieved. In both trials, fluoresceine isothicyanate conjugated BSA (FITC-BSA) was used due to the distinct absorption peak at 492 nm.

Relating to and demonstrating other embodiments of this invention, biomacromolecules (e.g., proteins, enzymes, peptides etc) were filtered through an Sn²⁺ modified polycarbonate membrane. For instance, the charge of such biomolecules can be altered by varying the pH, due to difference between isoelectric point of the biomolecules and pH of the medium. FIG. 12 shows the TEM image of ferritin nanotubes made from filtering the ferritin solution through an Sn²⁺ modified polycarbonate membrane.

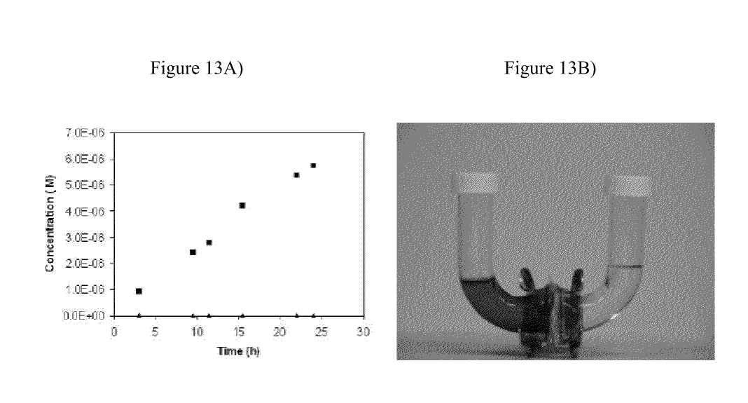

Relating to and exploring other aspects of this invention, a C6 polymer and poly(ethyleneimine) (PEI) functionalized polycarbonate membrane was used to separate molecules based on size. Here, C6 polymer (net negative charge) and PEI (net positive charge) were alternately deposited. Iterative deposition cycles (e.g., up to about 4 cycles or more) can be used to control pore size. Demonstrating such an effect and utility, two anions, Eriochrome black T (large anion) and sodium naphthalene sulfonate (small anion), were in the feed compartment (left side) of a U-tube apparatus. As represented in FIG. 13A, the anion is transported to the permeate with very high selectivity. The blue/dark color in FIG. 13B is due to the Eriochrome black T, and the permeate compartment (right side) remains without blue color even after a week, indicating the very efficient size-based separation of naphthalene sulfonate (small anion) from the mixture of small and large anions. Such results are representative of certain embodiments of this invention. Consistent therewith the number of deposition cycles can vary with initial pore diameter, polymer size and configuration and/or analyte dimension.

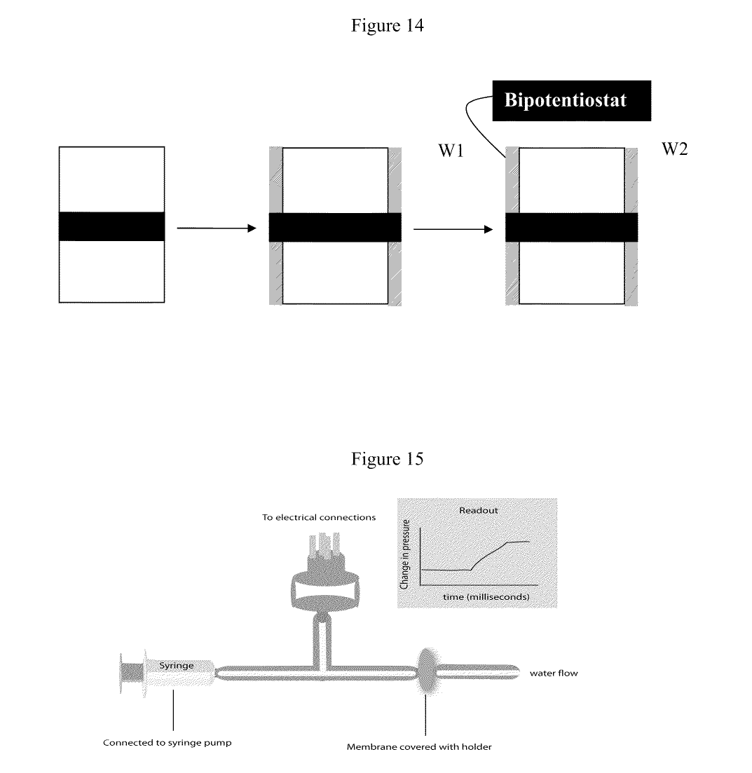

More generally, relating to a nanosensor apparatus of this invention refer to FIG. 14. A porous polycarbonate membrane can be treated with a conducting polymer (e.g., PEDOT-PSS). Both faces are evaporated with gold used as contact for electrochemical measurements. One face is connected to bipotentiostat working electrode 1 (W1) and the other face is connected to working electrode 2 (W2). A potential difference applied between electrodes will lead to a change in resistance. For sensing, the conducting polymer modified nanopores can provide a matrix of receptors. (E.g., specific receptors or binding components such as antibody, aptamer, etc., can be covalently or noncovalently connected with signal translating element such as conducting polymer resulting modified membrane and can be used for sensing specific analyte.) Upon binding between the introduced analyte and receptor, the conformation of the polymer transducer changes. Change in conformation leads to a change in resistance of the polymer, which is measured by the working electrodes. Various conjugated polymers and derivatives (e.g., polyaniline, polypyrrole and polythiophene) can be used as transducers.

Illustrating yet another sensor application of certain embodiments of this invention, refer to FIG. 15. A pressure sensor available from Omega Engineering Inc. is connected through a flexible tube to gas tight syringe and membrane containing holder, as shown, with the pressure sensor electrically connected to power source. The syringe pump, from New Era Pump Systems Inc., is used to deliver constant injection of water from the syringe and the read out is obtained through custom designed Lab view software. MilliQ water is filled into the system. Upon applied force from the syringe, the water passes through the membrane. The movement of water from one side to the other side of the membrane causes change in pressure, compared to the atmospheric pressure, inversely proportional to membrane dimension. As pore size decreases, increased pressure change can be observed. Illustrating such an approach, avidin interaction with a biotin functionalized nanoporous membrane can be detected and monitored.

Illustrating another embodiment of this invention, a sensor for angiogenic growth factor VEGF was fabricated, using PEDOT-PSS as transducer-cum-immobilization matrix. The receptor for the analyte specific sensor was VEGF aptamer. (Aptamers are synthetic receptors that are designed to bind with DNA, proteins, viruses and whole cells, and the VEGF protein specific aptamer was purchased from DHARMACON.) The PEDOT-PSS nanaotubes were prepared by filtration using polycarbonate membrane as template, and Mn²⁺ was filtered through the PEDOT-PSS to convert the negatively charged polymer nanotube to positively charged interior. Thereafter, 20 μL of VEGF-aptamer was dropped on one side of the electrode and the solution was allowed to pass through the interior of PEDOT-PSS nanotransducer. The same amount of VEGF aptamer was added to the other side of the electrode. The electrode was dipped in pH 7.4 phosphate buffer for 5 minutes to remove non-specifically adsorbed aptamer. The negatively charged aptamer adheres to the positively charged polymer nanotube interior. Finally, gold electrodes W1 and W2 are evaporated on both sides of the polycarbonate membrane.

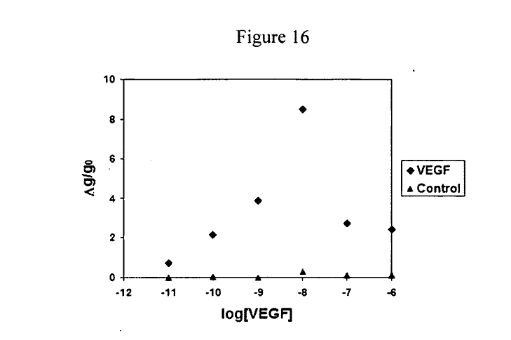

Sensor measurement was carried out as follows. The W1 and W2 are connected to the two leads of the bipotentiostat. The reference electrode was Ag/AgCl and the counter electrode was a steel foil. From in situ conductance measurements, the polymer's conductance was higher in the range of 0.2 to 0.4 V. Therefore, sensor measurements were obtained at 0.3 V vs Ag/AgCl. The sensor was first exposed to pH 7.4 buffer solution and the conductance was measured. This conductance is considered as g₀. Then the sensor was exposed to 1×10¹¹ g/ml of VEGF protein and the conductance was measured. Similarly, the conductance was measured for protein concentrations 1×10⁻¹⁰ g/ml, 1×10⁻⁹ g/ml, 1×10⁻⁸ g/ml, 1×10⁻⁷ g/ml and 1×10⁻⁶ g/ml. The conductance for various protein concentrations are considered as g. The sensor response is reported as Δg/g₀, where Δg is g-g₀. Sensor response as a function of concentration is shown in FIG. 16. The sensor detects VEGF concentration as low as 1×10⁻¹¹ g/mL. To further confirm that the sensor response is due to the binding between the aptamer and VEGF, control experiments were conducted using an Mn²⁺ immobilized PEDOT-PSS transducer. The transducer was exposed to protein concentrations ranging from 1×10⁻¹⁰ g/ml to 1×10⁻6 g/ml. The Δg/g₀ as a function of VEGF concentration is shown in the FIG. 16. There was no significant change in Δg/g₀ as a function of VEGF concentration, indicating there was no binding event on the surface of the polymer in absence of VEGF specific aptamer. Such experiments corroborate the use of nanotransducers prepared for selective and specific protein detection.

### EXAMPLES OF THE INVENTION

The following materials and methodologies, in conjunction with the foregoing, illustrate various aspects and features relating to the methods and apparatus of the present invention, including the separation and/or detection of various analytes or compounds of interest, as can be achieved as described herein. In comparison with the prior art, the present methods and apparatus provide results, and data which are surprising, unexpected and contrary thereto. While the utility of this invention is illustrated through the use of several polymeric compounds/substituents and analytes which can be separated and/or detected therewith, it would be understood by those skilled in the art that comparable results are obtainable with various other polymeric compounds/substituents and analytes/compounds interactive therewith, as are commensurate with the scope of this invention.

Membrane functionalization: Commercially available polycarbonate templates were immersed in a solution of SnCl₂ and trifluoroacetic acid for 45 min. This solution was prepared by dissolving 0.246 g of SnCl₂ and 0.3 mL of CF₃COOH in 50 mL of methanol:water (50:50) mixture. Then the membranes were washed with methanol. This Sn²⁺ modified membrane was then used for the preparation of polymer nanotubes. Typically, the Sn²⁺-modified membrane was masked with a cellophane tape leaving behind only a 2 cm² area in the middle. This membrane was then placed in a filter holder and an aqueous solution of the appropriate polymer (200 μL, 0.5 mg/ml) was passed through in vacuo. The filtration process was repeated thrice and copious amount of water was used to remove any unadsorbed polymer.

Pore size measurement: The pressure sensor (PX26-001DV) obtained from Omega Engineering Inc. was connected through flexible tube to gas tight syringe and membrane containing holder. The pressure sensor was also connected to power source, SCB-68 and NLPC1628 (card in the computer). The syringe pump (New Era Pump Systems Inc.) was used to deliver constant amount of water from the syringe and a custom designed Lab view software was used as readout. MilliQ water was filled in the syringe, upon applied force from the syringe the water passes through the membrane. The movement of water from one side to the other side of the membrane causes change in pressure. This change in pressure is calibrated against known pore size polycarbonate membranes obtained from SPI-Pore.

Transmission electron microscopy (TEM) imaging: TEM images were obtained using a JEOL 100CX operated at 100 keV without staining. The nanotube containing membrane was cut and placed on the carbon-coated TEM grid. Dichloromethane was dropped on the polymer to dissolve the membrane. Excess dichloromethane was removed using paper wipes.

U-tube experiment. The U-tube has feed and reservoir compartments separated by our functionalized membrane. Typically, dye molecules or proteins were dissolved in 10 mL of phosphate buffer solution (100 mmol or 10 mmol) and it was used as the feed, 10 mL of blank buffer was used as the reservoir solution. The concentration was 10⁻⁴ M for the dye molecules 0.5 mg/mL for the proteins.

As illustrated herein, this invention can provide for layer-by-layer polymer deposition and the opportunity for facile introduction or modification of functionality, with resulting separation selectivity. Corresponding reduction of pore diameter, further allows for nanodimensional control. Each subsequent polymer contact or deposition can provide corresponding sequential analyte separation, according analyte size, charge and/or the presence of one or more functional groups thereon.

We claim:

1. A method of preparing a functionalized nanopore coating composition, said method comprising:
providing a membrane component comprising nanodimensioned pores therethrough and walls thereabout; and
contacting said pore walls with at least a first polymeric compound comprising at least one separatory substituent, each said contact reducing pore diameter.

2. The method of claim 1 wherein said contact comprises successive deposition of said polymeric compound.

3. The method of claim 1 comprising contact of a second polymeric compound with said first contacted polymeric compound, said second polymeric compound comprising at least one separatory substituent.

4. The method of claim 3 comprising iterative contact of said first and second polymeric compounds, each said contact reducing pore diameter.

5. The method of claim 3 wherein at least a portion of said first polymeric compound comprises a net charge.

6. The method of claim 3 wherein at least a portion of said second polymeric compound comprises a net charge opposite said first polymeric compound, said polymeric compounds electrostatically interactive one with another.

7. A method of using polymeric deposition to affect nanoporous membrane separation, said method comprising:
providing a nanoporous membrane component;
depositing at least one polymeric compound on a pore wall of said membrane component, the last of said deposited compound comprising at least one separatory substituent, each said deposition reducing pore diameter; and
contacting said membrane component with a fluid medium comprising a first analyte, said last deposited polymeric compound selectively interactive with said first analyte.

8. The method of claim 7 wherein at least one of dimension, charge and hydrophilicity/hydrophobicity of said first analyte is interactive with said last deposited polymeric compound.

9. The method of claim 8 wherein said separatory substituent of said last deposited polymeric compound comprises a net charge, and said first analyte comprises a net charge opposite said separatory substituent net charge.

10. The method of claim 7 wherein said last deposited polymeric compound is amphiphilic, said polymeric compound comprising at least one hydrophilic separatory substituent and at least one hydrophobic separatory substituent, said polymeric compound variably selective for said first analyte in said fluid medium.

11. The method of claim 7 comprising deposition of at least another polymeric compound on said last deposited polymeric compound, said other polymeric compound comprising at least one separatory substituent; and contacting said membrane component with a fluid medium comprising a second analyte, said other polymeric compound selectively interactive with said second analyte.

12. The method of claim 11 wherein at least one of dimension, charge and hydrophilicity/hydrophobicity of said second analyte is interactive with said other deposited polymeric compound.

13. The method of claim 7 wherein said reduced pore diameter ranges from about 1 nm to about 100 nm.

14. The method of claim 13 wherein said pore diameter is less than about 25 nm.

15. A separation apparatus comprising a membrane component comprising opposed sides and a plurality of apertures therethrough; and at least one polymeric component coupled to the wall component of each said aperture, said polymeric component comprising at least one separatory substituent, each said aperture having a cross-dimension ranging from about 1 nm to about 100 nm.

16. The apparatus of claim 15 wherein said polymeric compound is coupled to said wall component with at least one other polymeric compound.

17. The apparatus of claim 15 wherein said coupled polymeric compound is selected from polyalkyleneimines, polyheterocycles, polyacrylic acids, polyacrylamides and polystyrenes.

18. The apparatus of claim 17 wherein a said separatory substituent of said polymeric compound is selected from amine, acid, acid salt, amide, and alkyl substituents and combinations of said substituents.

19. The apparatus of claim 15 wherein said aperture cross-dimension is less than about 25 nm.

20. The apparatus of claim 15 wherein said membrane component comprises a polycarbonate.
